(19) United States
(12) Patent Application Publication
(10) Pub. No.: US 2005/0276920 A1
(43) Pub. Date: Dec. 15, 2005

(54) Spin-coating apparatus for manufacturing semiconductor device and method of preventing transfer device from improperly positioning a wafer in the apparatus

(76) Inventor: Su-Hyun Kim, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/123,021

(22) Filed: May 6, 2005

(30) Foreign Application Priority Data
Jun. 9, 2004 (KR) 2004-42092

(51) Int. Cl. B05D 3/12; B05B 13/04; B05C 13/02

(52) U.S. Cl. 427/240; 118/52; 118/320; 427/294

(57) ABSTRACT

Spin-coating apparatus for use in manufacturing a semiconductor device or the like and a method of operation of the apparatus prevent substrates from being positioned incorrectly in a process module of the apparatus. The spin-coating apparatus includes an image sensor that captures an image of the wafer in the process module, and a control unit that receives image data from the image sensor. The method includes loading a substrate onto a process module using an arm of a transfer device, capturing an image of the substrate using the image sensor, and comparing image data generated by the image sensor with a standard image data stored to determine an actual position of the substrate. If the substrate is incorrectly positioned, the operation of the arm of the transfer device is adjusted to compensate.

### BACKGROUND OF THE INVENTION

1. Field of the Invention

The present invention relates to spin-coating apparatus for use in manufacturing a semiconductor device. More particularly, the present invention relates to a wafer transfer device which loads wafers into and unloads wafers from process modules in the apparatus.

2. Description of the Related Art

In general, a semiconductor device is manufactured by fabricating several circuits on a wafer. A typical one of such circuits is fabricated by forming a thin film on a wafer, coating the thin film with a layer of photoresist, transcribing an image corresponding to the circuit onto the layer of photoresist using a stepper, developing the layer of photoresist to pattern the layer, and etching the thin film using the patterned layer of photoresist as a mask.

Spin-coating apparatus are used for creating a thin uniform layer of photoresist on the thin film. Although the details of spin-coating apparatus vary from manufacturer to manufacturer, most apparatus generally include a coating unit including a spin chuck for holding and rotating the wafer while the photoresist is applied to the wafer, a side rinsing unit for cleaning an edge of the wafer after the photoresist has been applied thereto, a baking unit for curing the wafer or photoresist before or after the side rinse, and a wafer transfer device for transferring the wafer between the respective units of the apparatus. The side rinse unit has a structure similar to that of the coating unit. The spin-coating apparatus also includes a loading station onto and from which a wafer cassette is loaded and unloaded, and an alignment device for aligning the wafers supplied from the wafer cassette.

FIG. 1 is a perspective view of conventional spin-coating apparatus 100 for use in manufacturing a semiconductor device. FIG. 2a shows a wafer transfer device of the spin-coating apparatus, and FIGS. 2b and 2c show other process modules of the apparatus, respectively. A process of applying and developing the photoresist will now be described in detail with reference to FIGS. 1 through 2c.

First, a wafer cassette 131 with wafers 170 stacked therein is loaded onto a wafer cassette loading station 130 by an automatic guided vehicle (AGV) or a manual guided vehicle. Next, a wafer 170 is removed from the wafer cassette 131 by an index arm 141 of an alignment device. The wafer 170 is loaded onto an alignment stage 140 of the device, and is then aligned by a mechanism, such as roller, such that a flat zone of the wafer or a notch in the wafer is oriented in a desired direction.

The aligned wafer 170 is loaded into a baking unit 160 by one of the first and second main arms 151 and 152 of a wafer transfer device 150. At this time, if a wafer 170 is already present in the baking unit 160, the other of the first and second main arms 151 and 152 unloads the baked wafer from the baking unit 160.

The baked wafer 170 is transferred from the baking unit 160 to a coating unit 120, as shown in FIG. 2c. The coating unit 120 includes a spin chuck 121 for spinning the wafer 170 at a certain rotational speed. The wafer 170 is centered on the spin chuck 121 so that the photoresist will uniformly coat the entire surface of the wafer. The spin chuck 121 has a vacuum hole 122 through which a vacuum is created to adhere the wafer 170 to the chuck. At this time, if the wafer 170 is incorrectly loaded on the spin chuck 121, i.e., is not centered relative to the spin chuck 121, centrifugal force acting on the wafer may unseat the wafer 170 from the spin chuck 121.

Therefore, an operator should perform maintenance that prevents the wafer 170 from spinning off of the spin chuck 121. Notwithstanding such preventive maintenance, the wafer 170 may still yet come off of the spin chuck 121 when the coating unit 120 has been running for a long time. In this case, the operator confirms an optimum state of the wafer transfer device 150 by performing several tests of the main arms 151 and 152, and calibrates the wafer transfer device 150 accordingly to prevent the first and second main arms 151 and 152 from placing the wafer 170 incorrectly on the spin chuck 121. (The optimum calibration of the wafer transfer device based on testing will be referred to hereinafter as the “teaching” of the main arms).

Next, the first or second main arm 151 or 152 loads the wafer 170 into a side rinse unit 110 where photoresist is removed from the edge of the wafer 170. At this time, the teaching of the first and second main arms 151 and 152 is relevant to the side rinse operation because the side rinse unit 110 also includes a spin chuck 121.

The rinsed wafer 170 is then again loaded into the baking unit 160 by one of the first and second main arms 151 and 152 to cure the photoresist on the wafer. After the baking process, the wafer 170 is again loaded onto the wafer cassette 131 by the first or second main arm 151 or 152. The overall process described above is generally controlled by a control unit (not shown) of the spin-coating apparatus 100.

After all of the wafers 170 in the cassette 131 disposed at the wafer cassette loading station 130 have been processed as described above, the wafer cassette 131 is transferred from the wafer cassette loading station 130 to an exposing unit, such as stepper or scanner. Subsequently, each of the wafers 170 is removed from the cassette and loaded onto a stage of the exposing unit. Then, the photoresist layer the wafer 170 is then exposed to the image of a pattern of a photomask of the exposing unit, which pattern corresponds to the circuit pattern to be formed on the wafer.

However, the conventional spin-coating apparatus 100 has the following problems.

First, when the first and second main arms 151 and 152 are not placing the wafers 170 correctly on the spin chuck of the coating unit or side rinse unit, accidents occur. These accidents, resulting in scratches in or breakages of the wafer 170, can not be prevented because the spin-coating apparatus 100 has no means to monitor the calibration of the arm(s) 151 and/or 152 of the transfer device 150. The improper calibration of the arm or arms is only uncovered after the operation of the spin-coating apparatus 100 is stopped due to a process accident. Hence, the production yield of the conventional spin-coating apparatus is compromised by the inability of the apparatus to prevent such accidents from occurring.

Second, the first and second main arms 151 and 152 are taught to position the wafers 170 on the spin-chuck of the coating unit 120 or side rinse unit 110 by a technician. Hence, the teaching of the first and/or second main arm is subject to human error. This also affects the productivity of the spin-coating apparatus.

Finally, a technician must reside at the production line to manage the spin-coating apparatus, perform preventive maintenance and prevent production accidents due to the failure of the first and second main arms 151 and 152 to remain properly calibrated. Accordingly, the labor costs associated with running the conventional spin-coating apparatus are relatively high.

### SUMMARY OF THE INVENTION

Therefore, an object of the present invention is to provide spin-coating apparatus for manufacturing a semiconductor device and a method of operating the same, which prevent wafers or the like from being scratched or broken and thereby maximizing the yield of the apparatus.

Another object of the present invention is to provide spin-coating apparatus for manufacturing a semiconductor device and a method of operating the same, wherein a main arm of a transfer device is taught to position substrates in a process module without human intervention thereby minimizing the likelihood of accidents and maximizing the yield of the apparatus.

Still another object of the present invention is to provide spin-coating apparatus for manufacturing a semiconductor device and a method of operating the same, wherein the apparatus is interlocked when a process accident is in progress.

According to one aspect of the present invention, a spin-coating apparatus comprises a plurality of process modules, a transfer device having at least one main arm for transferring substrates to the plurality of process modules, at least one image sensor for capturing images of substrates as the substrates are loaded onto the process module by the main arm, and a control unit operatively connected to the image sensor and the main arm. The control unit is electronically configured to compare image data generated by the image sensor with stored standard image data, to use the comparison to determine the position of the substrate at the time the substrate is loaded onto the process module, and to teach the main arm of the transfer device to position the substrate more accurately if necessary.

Preferably, the process modules include a coating unit for coating an upper surface of the substrates with photoresist, a side rinsing for rinsing photoresist form the sides of the substrate, and a baking unit for baking the substrates coated with photoresist. The coating unit and the side rinsing unit each have a spin chuck. A respective image sensor is positioned relative to at least one such spin chuck in the apparatus to capture images of substrates after the substrates have been placed on the spin chuck by the main arm of the transfer device.

According to another aspect of the present invention, a method of operation of spin-coating apparatus comprises steps of: a) loading a substrate onto a process module using a main arm of a substrate transfer device, b) capturing an image of the substrate loaded on the process module, and comparing an data representing the image with stored standard image data to determine the position of the substrate, and c) adjusting the operation of the main arm to compensate for the extent to which the substrate has been incorrectly positioned on the process module.

According to still another aspect of the present invention, the standard image data represents an ideal position of the substrate in the process module. Preferably, this ideal position corresponds to a position at which the substrate is centered on the spin chuck of a respective process module. The operation of the main arm is adjusted (taught) only when the determination reveals that the substrate has been placed on the process module by the main arm in a position that differs from the ideal position but is within certain tolerances of the ideal position. On the other hand, when the determination reveals that the substrate has been placed on the process module by the main arm in a position that differs from the ideal position and is outside certain tolerances of the ideal position, an interlock signal is output to lock down the spin-coating apparatus.

### BRIEF DESCRIPTION OF THE DRAWINGS

The above and other features and advantages of the present invention will become more apparent to those of ordinary skill in the art from the following detailed description of the preferred embodiments thereof with reference to the attached drawings in which:

FIG. 1 is a perspective view of conventional spin-coating apparatus for use in manufacturing a semiconductor device;

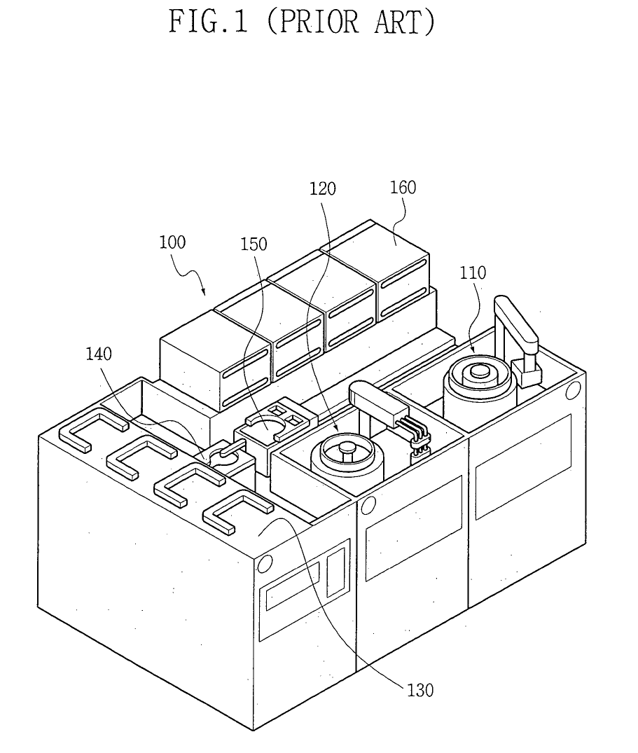

FIG. 2a is a perspective view of a wafer alignment device of the conventional spin-coating apparatus;

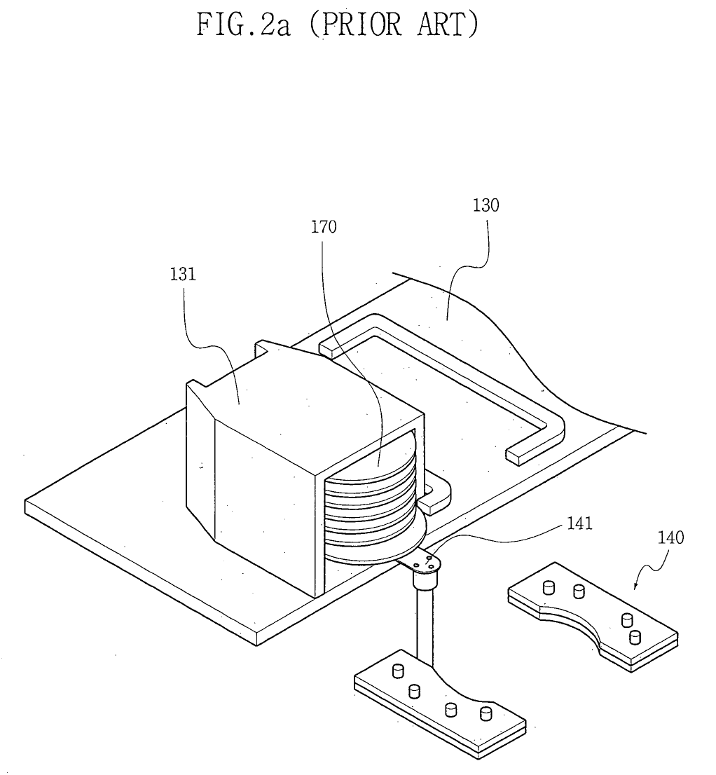

FIG. 2b is a perspective view of a wafer transfer unit of the conventional spin-coating apparatus;

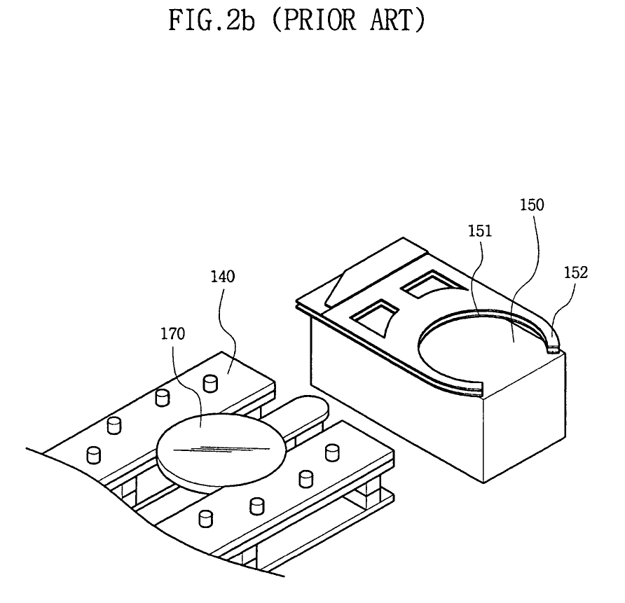

FIG. 2c is a perspective view a coating unit of the conventional spin-coating apparatus;

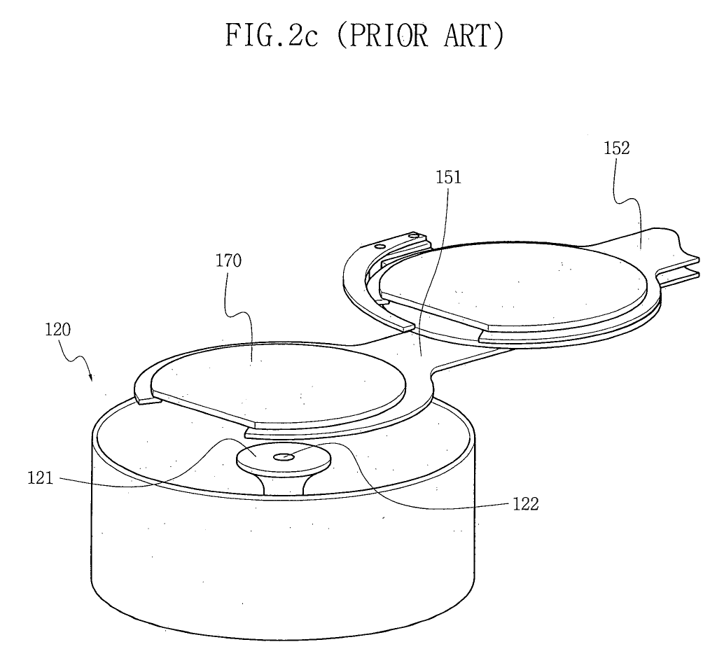

FIG. 3 is a perspective view of spin-coating apparatus for use in manufacturing a semiconductor device according to the present invention;

FIG. 4 is a perspective view of a coating unit and a wafer transfer device of the spin-coating apparatus shown in FIG. 3; and

FIG. 5 is a flowchart depicting a process of monitoring spin-coating apparatus to prevent process accidents from occurring according to the present invention.

### DETAILED DESCRIPTION OF THE PREFERRED EMBODIMENTS

The present invention will now be described more fully hereinafter with reference to the accompanying drawings. Like reference numbers designate like elements throughout the drawings.

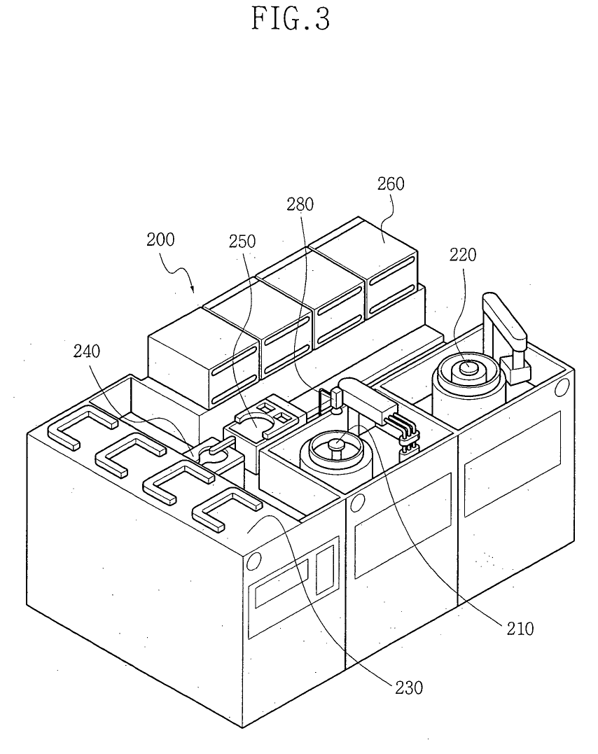

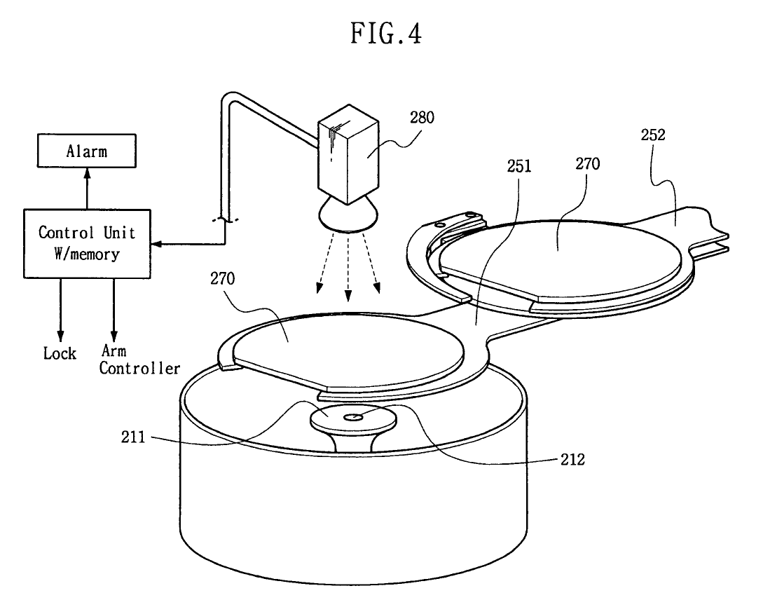

Referring to FIGS. 3 and 4, the spin-coating apparatus 200 according to the present invention includes a wafer cassette loading station 230 for supporting a wafer cassette, an alignment device 240 having an index arm for removing a wafer 270 from a wafer cassette at the wafer cassette loading station 230 and for aligning the wafer, a coating unit 210 for coating a surface of the wafer 270 with photoresist, a side rinsing unit for removing photoresist from the edge of the wafer 270, a baking unit 260 for curing the photoresist applied to the wafer 270, a wafer transfer device 250 for transferring the wafer throughout the apparatus, and at least one image sensor 280 for taking a picture of the wafer 270 transferred by the wafer transfer device 250.

The wafer transfer device 250 has first and second arms 251 and 252 for loading and unloading wafers into and from the coating unit 210, the side rinsing unit 220, and the baking unit 260. A respective image sensor 280 may be installed in the coating unit 210, the side rinsing unit 220, and/or the baking unit 260 for taking a picture of the wafer 270 as the wafer is loaded or unloaded by the first or second main arms 251 and 252. The image sensor 280 may be a charge-coupled device, for example.

The spin-coating apparatus 200 further includes a control unit for outputting control signals to control the coating unit 210, the side rinsing unit 220, the baking unit 260, the wafer transfer 250, and the first and second main arms 251 and 252. The control unit is also connected to each image sensor 280 so as to receive data of the images sensed by each image sensor 280. The control unit compares the data received from the image sensor(s) 280 with standard wafer image data stored in a memory of the control unit and, based on such a comparison, determines whether the wafer is being transferred in an optimal state. If the transferring of the wafer is not normal, an alarm is issued and the process is stopped. To this end, an audio or visual alarm-generating device is connected to the control unit.

The coating unit 210, the side rinsing unit 220, and the baking unit 260 each constitute a process module of the spin-coating apparatus 200. During the operation of the spin-coating apparatus 200 of the present invention, one of the main arms 251 and 252 of the wafer transfer device 250 unloads a processed wafer 270 from a process module as the other of the main arms 251 and 252 prepares to load another wafer 270 to be processed into the same process module. An example of this operation will be described with respect to the coating unit 260, as shown in FIG. 4. Of course, the first and second main arms 251 and 252 move into and out of the side rinsing unit 220 and the baking unit 260 in a similar way.

The coating unit 210 uniformly coat an upper surface of the wafer 270 with photoresist. More specifically, the coating unit 210 includes a photoresist supplier (not shown) that dispenses the photoresist onto the center of the wafer 270, and a spin chuck 211 for rotating the wafer such that the photoresist is dispersed across the entire surface of the wafer. To this end, the spin chuck 211 has vacuum system, e.g. a vacuum pump, a platen defining a vacuum hole connected to the vacuum system, and a motor connected to the platen. A vacuum created by the vacuum system is applied through the vacuum hole to a wafer transferred to the platen by the first or second main arm 251 or 252, whereby the wafer is adhered to the platen of the chuck. In this state, the platen is rotated by the motor connected thereto to rotate the wafer 270.

At this time, if the first or second main arm 251 or 252 has not centered the wafer 270 on the platen of the spin chuck 211, the wafer 270 may be spun off of the spin chuck, or the photoresist may not uniformly coat the upper surface of the wafer 270. More specifically, if the center of gravity of the wafer 270 is not positioned along the axis of rotation the spin chuck 270, the wafer 211 may be spun off of the spin chuck 211 by the centrifugal force produced due to the rotation of the wafer 270. Moreover, even if the centrifugal force is not great enough to unseat the wafer 270 from the spin chuck 211, the photoresist will flows more prominently in one direction. As a result, the upper surface of the wafer is coated unevenly with the photoresist.

However, according to the present invention, an image sensor 280 is disposed along the axis of rotation of the spin chuck 211 to take a picture of the wafer 270. Accordingly, the control unit is able to determine whether the wafer 270 has been correctly transferred to the coating unit 210 by the first or second main arm 251 or 252. That is, whether the main arm 251 or 252 has been properly calibrated or “taught” can be confirmed.

As described above, the first and second main arms 251 and 252 are controlled based on images of the wafer taken by the image sensor 280. However, the control unit may recalibrate the first and second main arms 251 and 252 using a plurality of photo sensors or limit switches (position sensors) that indicate the amount by which the first or second main arm 251 or 252 has been inserted into a process module, such as the coating unit 210. In this case, the control unit conforms the recalibration of the transfer device 250 using signals output by the position sensors. In any case, a technician is notified of the failure of the first or second main arm to remain properly calibrated via an alarm.

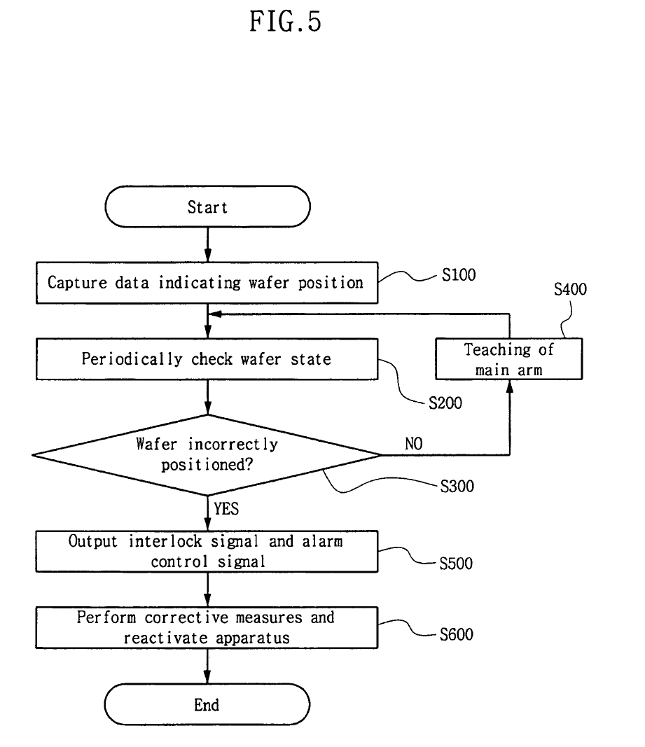

Now, a process of preventing wafers from being improperly positioned in the spin-coating apparatus according to the present invention will be described with reference to the flow chart of FIG. 5. First, the basic operation of the apparatus will now be described.

A wafer cassette having wafers 270 stacked therein is loaded onto the wafer cassette loading station 230 by an automatic guided vehicle (AGV) or a manually guided vehicle. A wafer 270 is taken out of the wafer cassette by an index arm 241 of the alignment device 240. The wafer 270 is then aligned by an aligning mechanism of the alignment device, such as roller, such that a flat zone of or notch in the wafer is oriented in a desired direction.

The aligned wafer 270 is loaded into the baking unit 260 by one of the first and second main arms 251 and 252 of the wafer transfer 250. At this time, if another wafer 270 is present in the baking unit 260, the other of the first and second main arms 251 and 252 first unloads the wafer from the baking unit 260.

A wafer 270 unloaded from the baking unit 260 is transferred to the coating unit 210, as shown in FIG. 4. Then, the wafer 270 is rotated and photoresist is dispensed onto a central region of the wafer 270. At this time, If the wafer 270 is not placed correctly on the spin chuck 211, i.e., is not centered relative to the axis of rotation of rotation of the spin chuck 211, the centrifugal force acting on the wafer 270 is unbalanced. The faster the spin chuck rotates, the greater the centrifugal force. Therefore, the wafer 270 may be detached from the spin chuck 211 at high speeds. Even at lower speeds, the upper surface of the wafer is coated unevenly with the photoresist.

Now, a process of preventing such process failures or defects in the spin-coating apparatus according to the present invention will be described with reference to FIG. 5.

First, as described above, the wafer 270 is positioned on the spin chuck 211 by the first or second main arm 251 or 252. The wafer 270 positioned on the spin chuck 211 by the first or second main arm 251 or 252 is photographed by the image sensor 280 (S100). To this end, the image sensor 280 may capture images constantly or at regular intervals under the command of the control unit.

The control unit periodically checks the state in which the wafers 270 are being positioned by use of the image signals output from the image sensor 280. The check is made once a certain number of wafers 270 have been placed on the spin chuck 211 or once the spin-coating apparatus 200 has been operating for a certain period of time (S200). In either case, the control unit compares the image data generated by the image sensor 280 with standard wafer image data stored in a memory of the control unit. The wafer image data is representative of an ideal position of the wafer on the spin chuck 211, e.g., a position at which the wafer is perfectly centered. Thus, the comparison reveals the actual position of the wafer 270.

Then, the control unit determines whether the positioning of the wafer by the first or second main arm 251 or 252 is off by an excessive amount, i.e., deviates from the ideal position by more than certain tolerances (S300). If the wafer is not at the ideal position and has not been mis-positioned by an excessive amount, the control unit nonetheless teaches the first or second main arm 251 or 252 to more accurately position the wafer on the spin chuck of the coating unit (S400). In this case, the control unit adjusts the operation of the main arm(s) by an appropriate “teaching” value, i.e., recalibrates the main arm(s). For example, the control unit adjusts the extent to which the arm is inserted into the coating unit 210 and confirms such an adjustment by detecting the position of the arm using an array of position sensors (for example, photo sensors or limit switches). The use of photo sensors or limit switches to sense the position of a mechanical element is known, per se, and thus, will not be described in more detail.

If the position of the wafer on the spin chuck deviates from an ideal position by an excessive amount, e.g., if the wafer slides off of the spin chuck, the image data generated by the image sensor deviates significantly from the standard image data stored in the memory of the control unit. In this case, the control unit cannot adjust the first or second main arms 251 or 252 enough to compensate for its failure to position a wafer on the spin chuck accurately enough. Accordingly, the control unit outputs an interlock signal to the spin-coating apparatus 200 to stop the operation of the apparatus. Also, the control unit outputs a command to activate the alarm device and thereby signal an accident in progress (S500).

Next, a technician uncovers the cause of the accident, and performs corrective measures. Then, the spin-coating apparatus may be tested and reactivated (S600). For example, the operator loads a test wafer or jig into the apparatus, whereby the spin chuck 211 the first or second main arm 251 or 252 loads the test wafer or jig onto the spin-chuck. The operation illustrated in FIG. 5 is repeated using the test wafer or jig until the test indicates that the spin-coating apparatus is performing acceptably.

According to the method of the present invention, the control unit automatically and periodically teaches the first main arm 251 and/or second main arm 252 to position the wafer 270 in a process module. Therefore, accidents associated with a failure of the arm(s) to remain calibrated are unlikely to occur, whereby the productivity of the spin-coating apparatus is maximized.

Also the teaching of the first and second main arms 251 and 252 applies to the side rinse operation because the side rinsing unit 220 also includes a spin chuck.

Still further, even when the control unit can not adjust the first main arm 251 and/or second main arm 252 to prevent an accident from occurring, the control unit generates an interlock signal and activates an alarm device. Thus, the spin-coating apparatus is shut down immediately to prevent subsequent wafers from being damaged. Moreover, the operator is notified that the spin-coating apparatus must be examined to uncover the cause of a significant malfunction.

Finally, although the present invention has been described above in connection with the preferred embodiments thereof, the invention may be embodied differently. Accordingly, modifications of and changes to the disclosed embodiments are seen to be within the true spirit and scope of the invention as defined by the appended claims.

1. Spin-coating apparatus comprising:
a plurality of process modules each of which process a substrate;
at least one main arm that loads substrates onto the plurality of process modules;
a respective image sensor associated with each of at least one of the process modules and positioned relative to the module so as to capture an image of the substrate as the substrate is loaded onto the process module by the main arm, and the image sensor operative to output image data representative of the image captured by thereby; and
a control unit connected to each said respective image sensor so as to receive the image data output by the image sensor, the control unit including a memory in which standard image data is stored, the control unit operative to compare the image data with the standard image data, and the control unit being operatively connected to at least one of the main arms so as to control the movement of the at least one main arm, whereby the control unit can control the position at which the wafer is placed onto at least one of the process modules by the at least one main arm.

2. The spin-coating apparatus according to claim 1, wherein each of the at least one image sensors is a charge coupled device.

3. The spin-coating apparatus according to claim 2, further comprising an alarm connected to the control unit.

4. The spin-coating apparatus according to claim 1, wherein at least one the process modules is a unit including a spin chuck, and a said image sensor is positioned relative to the spin chuck so as to capture an image of a substrate loaded onto the spin chuck.

5. A method of operation for use in spin-coating apparatus, the method comprising:
loading a substrate onto a process module using a main arm of a transfer device;
capturing an image at a location at which the substrate should be loaded onto the process module, and generating image data representative of the image;
comparing the image data with standard image data stored in a memory;
based on the comparison, determining whether the substrate has been positioned incorrectly on the process module by the main arm; and
adjusting the operation of the main arm to compensate for the extent to which the substrate has been incorrectly positioned on the process module.

6. The method according to claim 5, wherein the capturing of the image is performed only periodically.

7. The method according to claim 5, wherein the adjusting of the operation of the main arm comprises detecting the position of the main arm using a position sensor.

8. The method according to claim 5, wherein the process module is a unit including a spin chuck, and the capturing of the image comprises capturing an image at the location of the spin chuck.

9. A method of operation for use in spin-coating apparatus, the method comprising:
loading a substrate onto a process module by a main arm;
capturing an image at a location at which the substrate should be loaded onto the process module by the main arm, and generating image data representative of the image;
comparing the image data photographed with standard image data stored in a memory, the standard image data representing an ideal position of the substrate in the process module;
based on the comparison, determining an actual position at which the substrate has been placed on the process module by the main arm;
when the determination reveals that the substrate has been placed on the process module by the main arm in a position that differs from the ideal position but is within certain tolerances of the ideal position, adjusting the operation of the main arm to compensate for the extent to which the actual position differs from the ideal position; and
when the determination reveals that the substrate has been placed on the process module by the main arm in a position that differs from the ideal position and is outside certain tolerances of the ideal position, outputting an interlock signal that locks down the spin-coating apparatus.

10. The method according to claim 9, wherein the process module is a unit including a spin chuck, and the capturing of the image comprises capturing an image at the location of the spin chuck.
